(19) United States
(12) Patent Application Publication
(10) Pub. No.: US 2020/0040858 A1
(43) Pub. Date: Feb. 6, 2020

(54) Valve Assembly for a Fuel Injection System, and Fuel Injection System

(71) Applicant: Continental Automotive GmbH, Hannover (DE)

(72) Inventor: Max SCHELLER, Stamsried (DE)

(21) Appl. No.: 16/482,440

(22) PCT Filed: Mar. 1, 2018
(86) PCT No.: PCT/EP2018/055117

§ 371 Date: Jul. 31, 2019

(30) Foreign Application Priority Data
Mar. 23, 2017 (DE) 10 2017 204 925.1

(51) Int. Cl. F02M 63/00; F02M 59/46; F16K 15/04; F16K 27/02

(52) U.S. Cl. CPC F02M 63/005; F02M 59/462; F16K 27/0245; F16K 15/044; F16K 27/0209; F16K 15/042

(57) ABSTRACT

A valve arrangement for a fuel injection system includes a first valve unit (42) having a first flow cross section (Q₁) and a second valve unit (44) having a second flow cross-section Q₂). The second valve unit includes at least two single valves (48), each of which has a single valve flow cross-section Q_{E}). The second flow cross-section (Q₂) is formed by a sum of the single valve flow cross-sections (Q_{E}). A fuel injection system (10) incorporates such a valve arrangement (22).

The invention relates to valve arrangement for a fuel injection system of an internal combustion engine, and a fuel injection system which has such a valve arrangement.

In so-called common-rail fuel injection systems, the generation of pressure in a fuel which is to be burned in an internal combustion engine and the injection of the fuel into combustion chambers of the internal combustion engine are uncoupled. In this case, a high-pressure fuel pump compresses the fuel supplied to it from a low-pressure region, for example from a tank. On the output side of the high-pressure fuel pump, a volume flow of the compressed fuel then flows to a high-pressure reservoir, the so-called common rail, from where the compressed fuel is then injected into the combustion chambers of the internal combustion engine. In this case, the high-pressure fuel pump generates a pressure in a range of 150 bar to 400 bar, for example, if the fuel is petrol, and a pressure in a range of 1500 bar to 3000 bar if the fuel is diesel. The respective fuel is under this generated high pressure in the high-pressure reservoir and is supplied from the high-pressure reservoir to the combustion chambers of the internal combustion engine via injection valves.

To ensure proper functioning of the fuel injection system and to enable any special requirements to be fulfilled, a fuel injection system generally has two valves, namely an outlet valve on the one hand and a pressure-limiting valve on the other. The outlet valve functions as a high-pressure valve, which—if the high-pressure fuel pump is designed as a piston pump—opens during an upward movement of a pump piston so that the fuel can be delivered into the high-pressure reservoir. During the downward movement of the pump piston, the outlet valve closes so that a return flow of the compressed fuel from the high-pressure reservoir back into the pressure chamber is prevented.

The pressure-limiting valve has the function of preventing too great a pressure increase in the high-pressure reservoir. If the pressure in the high-pressure reservoir exceeds a particular value, a certain volume flow of the fuel is either directed into the high-pressure region or into the low-pressure region via-the pressure-limiting valve.

Each of the above-mentioned valves—outlet valve and pressure-limiting valve—is integrated, for example, separately in a housing of the high-pressure fuel pump. This requires a very large installation space, thereby lowering the efficiency of the high-pressure fuel pump, and connection to the high-pressure fuel pump under higher system pressures becomes difficult or can no longer be realised.

Alternatively, it is, for example, also known to provide the pressure-limiting valve and the outlet valve in successive series, although this leads to inconsistent guidance of the fuel as a fluid across a plurality of changes in direction, and can moreover lead to an undesired drop in pressure and a reduction in the fatigue strength as a result of cavitation and erosion.

The outlet valve and the pressure-limiting valve usually require a similarly sized installation space. The first variant described above, a planar parallel arrangement of the two valves next to one another, results in a very large assembly, although it can be implemented depending on the necessary flow. However, the connection of such a large assembly is subject to limitations, both technically and financially.

A geometrical series connection, which is, however, functionally also a parallel connection and which is addressed in the second variant, is associated with hydraulic disadvantages. To ensure the inflow to the valves, bore intersections are namely required, which lead to a greater loss of pressure and a partially higher flow rate. Both lead to a reduction in the fatigue strength both of the valves and of the high-pressure fuel pump as a whole.

The object of the invention, therefore, is to propose an improved valve arrangement for a fuel injection system.

This object is achieved by a valve arrangement having the feature combination of claim 1.

A fuel injection system which has such a valve arrangement is the subject matter of the coordinate claim.

Advantageous configurations of the invention are the subject matter of the dependent claims.

A valve arrangement for a fuel injection system of an internal combustion engine has a valve housing for receiving elements of at least one valve unit, wherein a first valve unit having a first flow cross-section and a second valve unit having a second flow cross-section are received in the valve housing. The first valve unit and the second valve unit are connected antiparallel to one another. The second valve unit has at least two mutually hydraulically separate, parallel-connected single valves, which each have a single valve flow cross-section. The second flow cross-section of the second valve unit is formed by a sum of the single valve flow cross-sections.

By dividing the second valve unit into a plurality of small single valves whereof the single valve flow cross-sections form the entire second flow cross-section of the second valve unit, the best possible use can be made of an available installation space in the valve housing in which the first and the second valve unit are accommodated. It is thus possible to counter the disadvantage of the similarly sized installation spaces of, for example, an outlet valve and a pressure-limiting valve in a fuel injection system since one of the two valves is divided into a plurality of single valves.

In this case, “flow cross-section” is understood to mean a cross-section which is available for a fluid, for example a fuel, flowing through the respective valve unit to flow through the valve unit when the valve unit is in its maximum open position. The flow cross-section does not necessarily have to be formed by one single valve, but can also be made up of single valve flow cross-sections in a simple additive process.

The term “antiparallel” or “parallel” should be understood as follows: A valve unit has an inflow region and an outflow region, which are separated from one another by a valve element closing the valve unit. The valve unit therefore has two sides, namely the inflow region and the outflow region. In an antiparallel arrangement of two valve units, with regard to their valve elements, the inflow region of the one valve is arranged adjacent to the outflow region of the other valve and vice versa. In a “parallel” arrangement, on the other hand, the two inflow regions of the two valve units and the two outflow regions of the two valve units are arranged directly adjacent to one another.

In a possible embodiment of the valve arrangement, the at least two single valves have mutually different single valve flow cross-sections. However, it is alternatively also possible that the at least two single valves have the same single valve flow cross-sections. It is merely essential that the single valve flow cross-sections of the at least two single valves add up to the desired second flow cross-section of the second valve unit. In the first alternative, it is possible to focus the flow direction of the fluid flowing through the second valve unit specifically on a particular single valve when this has a larger single valve flow cross-section than the further single valve(s). As a result, the flow preferably passes through this one single valve. In the second alternative, on the other hand, the flow passes equally through the single valves as they have the same single valve flow cross-section(s).

The at least two single valves preferably have mutually different opening pressures. As a result, if the second valve unit is formed by a pressure-limiting valve in a fuel injection system, it is possible, for example, to counter different overpressure situations in the fuel injection system, wherein the single valves can open at different pressure times. If the single valves are formed, for example, as check valves having a valve element which is simply pre-tensioned via a spring, the opening pressures of the single valves can be adjusted via the spring constant, i.e. pre-tensioning springs having different spring constants are used for the single valves, for example.

The first valve unit is advantageously formed by one single valve.

The second valve unit further advantageously has three to five single valves. As a result of the first valve unit merely being formed by one single valve, the entire first flow cross-section is provided by this single valve, which means that that this single valve is considerably larger than the multiplicity of single valves of the second valve unit. As a result, the small single valves of the second valve unit can be incorporated in an installation space of the valve housing which has to be available in any case for the large single valve of the first valve unit but which is not used in its entirety. As a result, the proportion of unused installation space in the valve housing is reduced considerably.

The single valves of the second valve unit and the first valve unit are preferably arranged symmetrically around a valve housing longitudinal axis of the valve housing on a cross-sectional surface which is perpendicular to the valve housing longitudinal axis.

As a result, the installation space around the first valve unit, which has to be available in the valve housing in any case for the first valve unit, can be used particularly advantageously for the arrangement of the single valves of the second valve unit. This is because three to five small single valves can be comfortably arranged around the first valve unit, formed as one single valve, in the valve housing.

As a result of the symmetrical arrangement of the single valves which form the second valve unit or the first valve unit, a consistent fluid flow in the valve arrangement can be achieved, which can reduce erosion and cavitation in the valve arrangement.

A modular construction of the valve arrangement is further simplified by a symmetrical arrangement of the valve units. This is because, depending on the application of the valve arrangement, it is possible to vary the number of single valves of the second valve unit. However, the valve housing does not have to be altered in this case; instead, the precise number of single valves required for the respective application are incorporated in the valve housing and, if a smaller number is required, the surplus single valves are simply omitted.

The valve housing advantageously has an associated valve bore for each single valve to be received, wherein the valve bores are arranged parallel to one another, mutually hydraulically separate. Bore intersections can thus be avoided and, as a result of the improved hydraulic guidance of the fluid through the valve bores, a loss of pressure and partially higher flow rates of the fluid are prevented.

The valve bores are preferably formed as blind bores.

The valve bore of the first valve unit advantageously has convex outflow portions arranged radially with respect to a valve unit longitudinal axis of the first valve unit. In this case, valve bores associated with single valves of the second valve unit are arranged between two convex outflow portions in each case. As a result of these convex outflow portions, a sufficiently free cross-section for the flow of fluid through the first valve unit is provided. Depending on the arrangement, for example in the case of a flower-shaped arrangement of the convex outflow portions, a region of the valve housing is then available which is needed for forming the convex outflow portions but cannot be used for the first valve unit. The single valves of the second valve unit can then be specifically accommodated in this region to thereby achieve better use of the available space.

The valve bores preferably have a step for forming a valve seat for a closing element or for forming a supporting geometry for a valve spring. The other element in each case—valve seat or supporting geometry—which is not formed by a valve bore can then be formed by a corresponding sleeve. If one of the two elements is formed by the step in the valve bore, a further sleeve can advantageously be omitted.

A fuel injection system for an internal combustion engine has a high-pressure fuel pump having a pressure chamber, in which a pump piston moves for highly pressurizing a fuel during operation. The fuel injection system further comprises a high-pressure reservoir for storing the fuel which is highly pressurised in the high-pressure fuel pump. In addition, a valve arrangement as described above is provided to connect the pressure chamber to the high-pressure reservoir. The valve arrangement has an outlet valve unit, which serves as a barrier against a pressure force acting from the high-pressure reservoir, and a pressure-limiting valve, which serves as a barrier against a pressure force acting from the pressure chamber.

In this case, in a first embodiment, the outlet valve unit can be formed by the first valve unit and the pressure-limiting valve unit can be formed by the second valve unit.

However, it is alternatively also possible that the pressure-limiting unit is formed by the first valve unit and the outlet valve unit is formed by the second valve unit.

The fuel injection system advantageously has a connecting bore between the pressure chamber and the high-pressure reservoir, in which the valve arrangement is arranged.

In this case, the connecting bore can be formed for example in a pump housing of the high-pressure fuel pump or in a high-pressure connection, which forms a connecting element between the pump housing and the high-pressure reservoir. However, it is also possible that the connecting bore extends over both elements—pump housing and high-pressure connection.

In a possible embodiment, wall regions of this connecting bore form the valve housing of the valve arrangement. This means that elements of the valve units, such as valve seats, pre-tensioning springs, closing elements, are arranged individually in the correspondingly formed connecting bore. In this case, the elements can be fixed in the connecting bore, for example, by pressing or crimping, or also by welding.

However, it is alternatively also possible that the valve arrangement is formed in a cartridge housing which is pre-assembled outside the fuel injection system, wherein the cartridge housing is fixed, as a whole, in the connecting bore. Fixing by means of pressing and crimping or welding is also possible here.

The valve arrangement is advantageously arranged on a pump housing of the high-pressure fuel pump such that the valve bores in the valve arrangement are arranged substantially perpendicularly to a movement axis of the pump piston of the high-pressure fuel pump.

If the valve bores are arranged in a high-pressure connection, the high-pressure connection is advantageously formed such that it has a main bore which is intersected by the valve bores.

Advantageous configurations of the invention are explained in more detail below with reference to the accompanying drawings, which show:

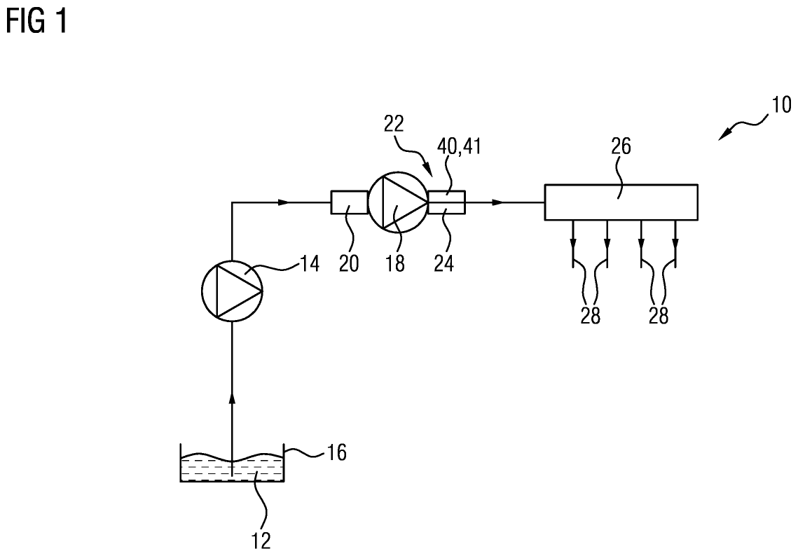

FIG. 1 a schematic illustrated overview of a fuel injection system having a high-pressure fuel pump and a high-pressure reservoir, between which a valve arrangement is arranged;

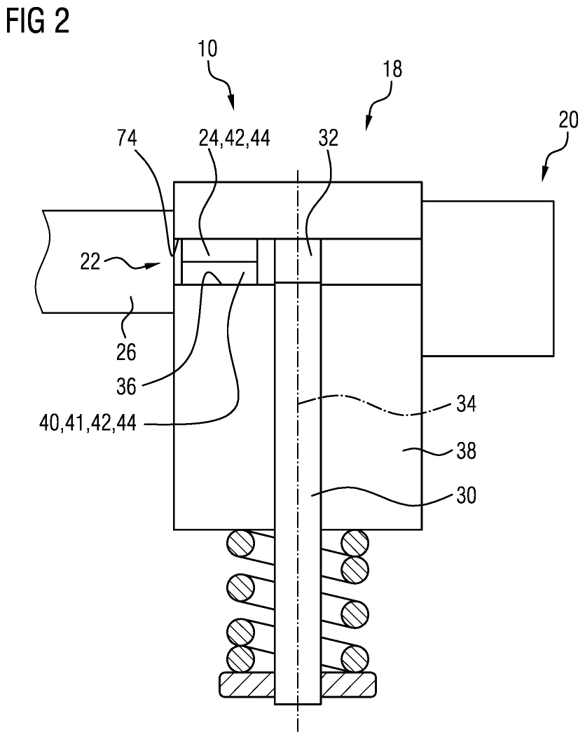

FIG. 2 a sectional illustration of a section of the fuel injection system of FIG. 1, wherein a connecting bore, having a valve arrangement arranged therein, is arranged between the high-pressure reservoir and a pressure chamber of the high-pressure fuel pump;

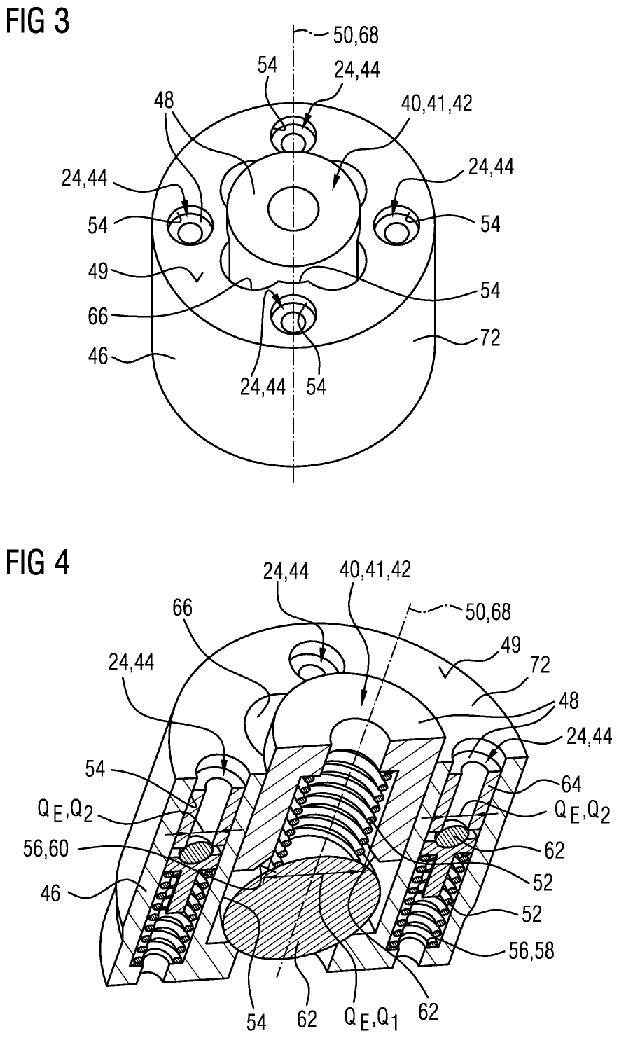

FIG. 3 a perspective illustration of a first embodiment of the valve arrangement of FIG. 2;

FIG. 4 a perspective sectional illustration of the valve arrangement of FIG. 3;

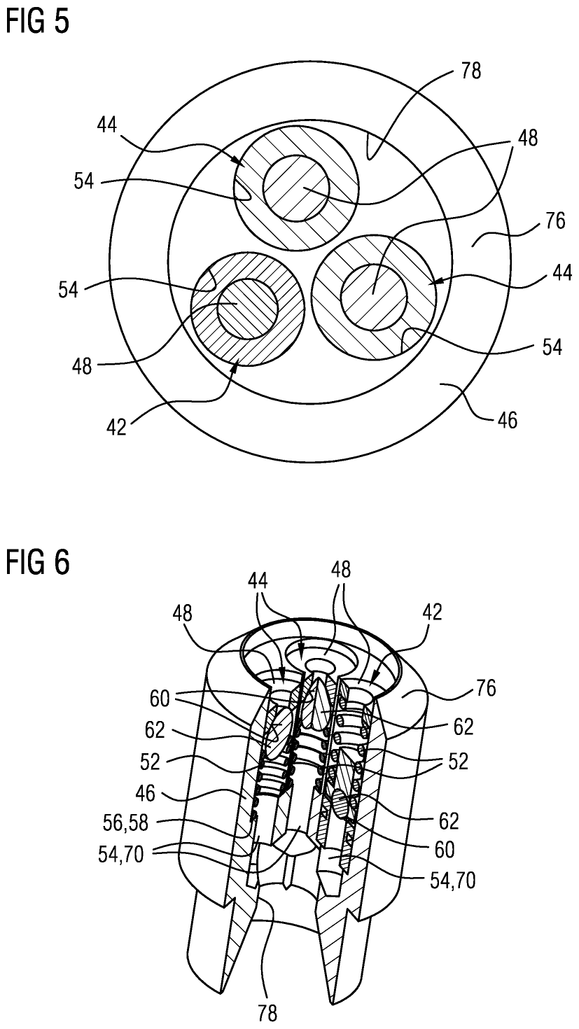

FIG. 5 a plan view of a valve arrangement according to FIG. 2 in a second embodiment; and

FIG. 6 a perspective cut-open illustration of the valve arrangement of FIG. 5.

FIG. 1 shows a schematic illustrated overview of a fuel injection system 10, in which a fuel 12 is delivered from a tank 16 to a high-pressure fuel pump 18 by a pre-delivery pump 14. The fuel 12 is highly pressurised in the high-pressure fuel pump 18, wherein the quantity of fuel 12 which is pressurised in the high-pressure fuel pump 18 can be adjusted by actively controlling an inlet valve 20 accordingly. The pressurised fuel 12 is then supplied via a valve arrangement 22, which has an outlet valve unit 24, to a high-pressure reservoir 26 at which injectors 28 are arranged, via which the pressurised and stored fuel 12 can be injected into combustion chambers of an internal combustion engine.

The high-pressure fuel pump 18 is shown in greater detail in FIG. 2 in a sectional illustration of a section of the fuel injection system 10. In the present embodiment, it is formed as a piston pump and therefore has a pump piston 30 which, during operation, moves up and down in a translatory movement along a movement axis 34 in a pressure chamber 32 of the high-pressure fuel pump 18. As a result of this movement, the fuel 12 located in the pressure chamber 32 is compressed and therefore pressurised. The pressurised fuel 12 then arrives in the high-pressure reservoir 26 from the pressure chamber 32 via a connecting bore 36 which, in the present embodiment, is arranged in a pump housing 38 of the high-pressure fuel pump 18.

To enable a desired pressure to be provided in the fuel 12 located in the high-pressure reservoir 26, a valve arrangement 22 is arranged in the connecting bore 36, which valve arrangement, in a first embodiment, is shown in a perspective illustration in FIG. 3.

The valve arrangement 22 comprises the outlet valve unit 24, which ensures that only fuel 12 at the desired pressure exits the pressure chamber 32 in the direction of the high-pressure reservoir 26. Moreover, it prevents a return flow of the compressed fuel 12 back into the pressure chamber 32 when an underpressure is generated there by a downward movement of the pump piston 30.

The valve arrangement 22 further comprises a pressure-limiting valve unit 40. This pressure-limiting valve unit 40 prevents too great a pressure increase in the high-pressure reservoir 26 since, when the pressure in the high-pressure reservoir 26 exceeds a particular value, a certain volume flow of the fuel 12 is directed back into the pressure chamber 32 via the pressure-limiting valve unit 40.

In a first embodiment shown in FIG. 3 and FIG. 4, the outlet valve unit 24 forms a first valve unit 42 in the valve arrangement 22 and the pressure-limiting valve unit 40 forms a second valve unit 44. The two valve units 42, 44 are received together in a valve housing 46. Since the pressure-limiting valve unit 40 serves as a barrier against a high pressure from the pressure chamber 32, and the outlet valve unit 24 serves as a barrier against a high pressure from the high-pressure reservoir 26, the first valve unit 42 and the second valve unit 44 are connected antiparallel to one another.

It can be seen that the first valve unit 42 is formed by one single valve 48, whilst the second valve unit 44 is composed of a plurality of, namely four, single valves 48. The single valves 48 of the second valve unit 44 are hydraulically separate from one another and serve as a barrier against the same high pressure, namely that which acts from the pressure chamber 32, which is why the single valves 48 of the second valve unit 44 are connected in parallel.

The single valve 48 of the first valve unit 42 and also the single valves 48 of the second valve unit 44 each have their own single valve flow cross-section Q_{E}. This should be understood to refer to the cross-section which is available for the fuel 12 when it flows through the relevant single valve 48 in the fully open state of this single valve.

Since the first valve unit 42 only has one single valve 48, the single valve flow cross-section Q_{E} also simultaneously forms the entire first flow cross-section Q₁ for the first valve unit 42. In contrast to this, however, the second valve unit 44 is formed from a plurality of smaller single valves 48, which each have a separate single valve flow cross-section Q_{E}. Since these single valves 48 are hydraulically connected in parallel, the single valve flow cross-sections Q_{E} of the single valves 48 of the second valve unit 44 add up to the second flow cross-section Q₂.

As a result of this arrangement shown in FIG. 3 and FIG. 4, it is possible to direct a large quantity of fuel 12 out of the high-pressure reservoir 26 via the second valve unit 44 in the event of an overpressure, although the installation space required is smaller than if the second valve unit 44, analogously to the first valve unit 42, were merely formed by one single valve 48 arranged, for example, adjacent to the single valve 48 of the first valve unit 42. Instead, the second valve unit 44 is divided into a plurality of smaller single valves 48, which are arranged distributed around the first valve unit 42 in the installation space required in any case for the first valve unit 42.

As a result, a compact construction of a valve arrangement 22, which has both an outlet valve unit 24 and a pressure-limiting valve unit 40, can be achieved.

In the embodiment shown in FIG. 3 and FIG. 4, the pressure-limiting valve unit 40 is, for example, divided into four small pressure-limiting valves 41 and these four small pressure-limiting valves 41 are integrated in an unused installation space of the outlet valve unit 22.

To make optimum use of the installation space of the valve housing 46, the single valves 48 of the two valve units 42, 44 are arranged symmetrically around a valve housing longitudinal axis 50 on a cross-sectional surface 49 which is perpendicular to the valve housing longitudinal axis 50. In particular, in this case, the single valves 48 of the second valve unit 44 are arranged symmetrically, namely circularly, around the first valve unit 42.

In the present embodiment of the valve arrangement 22, which is described below, the first valve unit 42 is formed by the outlet valve unit 24, whilst the second valve unit 44 is formed by the pressure-limiting valve unit 40. However, the reverse is also possible, in that the first valve unit 42 is formed by the pressure-limiting valve unit 40 and the second valve unit 44 is formed by the outlet valve unit 24.

The single valves 48 of the second valve unit 44 are illustrated as having the same form in the embodiment shown in FIG. 4. This means that they have the same single valve flow cross-section Q_{E}. However, it is also alternatively possible that the single valve flow cross-sections Q_{E} of the single valves 48 of the second valve unit 44 differ from one another depending on the requirements of the valve arrangement 22. In addition, it is also conceivable that the single valves 48 of the second valve unit 44 have different opening pressures and therefore open under different pressure conditions in the high-pressure reservoir 26 or in the pressure chamber 32.

In all of the embodiments shown, the first valve unit 42 and the single valves 48 of the second valve unit 44 are formed as robust ball cone check valves and have a cylindrical or conical valve spring 52. However, alternative embodiments are also conceivable.

As can be seen in FIG. 3 and FIG. 4, the valve housing 46 has an associated valve bore 54 for each single valve 48 to be received, wherein the valve bores 54 are arranged hydraulically separate from one another and parallel to one another. As a result, the installation space is used optimally along the valve housing longitudinal axis 50 and bore intersections, which should be seen as a critical factor in terms of the efficiency of the fuel injection system 10 and the reduction in the fatigue strength of components of the valve arrangement 22, can be eliminated.

The valve bores 54 of the single valves 48 of the second valve unit 44 each form a step 56, which provides a supporting geometry 58 for a valve spring 52 of the relevant single valve 48.

In the first valve unit 42, the associated valve bore 54 likewise forms a step 56, although this does not provide a supporting geometry 58 for the valve spring 52 but, instead, a valve seat 60 for a closing element 62 of the second valve unit 44.

In the second valve unit 44, the valve seats 60 are each formed by a corresponding sleeve 64, whilst the supporting geometry 58 for the valve spring 52 in the first valve unit 42 is provided by such a sleeve 64.

As further revealed in FIG. 3, the first valve unit 42 has an outflow geometry in the form of convex outflow portions 66, which are formed in the valve bore 54 and are shaped radially with respect to a valve unit longitudinal axis 68 of the first valve unit 42. In this case, the convex outflow portions 66 are formed in a flower shape substantially perpendicularly to the valve unit longitudinal axis 68. In this case, the valve bores 54, in which the single valves 48 of the second valve unit 44 are arranged, are arranged between two convex outflow portions 66 in each case. As a result, maximum use of the installation space of the valve housing 46 can be realised.

FIG. 5 and FIG. 6 show a second embodiment of the valve arrangement, in which the second valve arrangement 44 is not formed by several single valves 48 but merely by two single valves 48. However, the single valves 48 of the two valve arrangements 42, 44 are also arranged symmetrically around the valve housing longitudinal axis 50 here, namely in the form of a triangle.

It can further be seen in FIG. 6 that the single valves 48 are arranged in valve bores 54 which are formed as blind bores 70.

The essential difference between the first embodiment according to FIGS. 3 and 4 and the second embodiment according to FIGS. 5 and 6 can be seen in that, in the first embodiment, the valve arrangement 22 is formed in a cartridge housing 72, which forms an independent complete assembly which can be fully pre-assembled and tested outside the fuel injection system 10 and merely has to be fixed in place, for example by pressing, crimping or welding the cartridge housing 72 into the connecting bore 36. In contrast to this, in the second embodiment according to FIG. 5 and FIG. 6, the valve bores 54 in which the single valves 48 of the first and second valve unit 42, 44 are to be accommodated are formed by wall regions 74 of the connecting bore 36 which connects the high-pressure reservoir 26 to the pressure chamber 32.

In the present embodiment according to FIG. 6, this connecting bore 36 is formed in a high-pressure connection 76, which has a main bore 78 in which the individual valve bores 54 are incorporated. To enable this to be realised particularly easily, it is advantageous if the individual valve bores 54 are formed as blind bores 70.

An intersection of the individual valve bores 54 with the main bore 78 of the high-pressure connection 76 is therefore important, which intersection substantially provides a mostly customer-specific or standard outlet bore for discharging fuel 12 from the high-pressure fuel pump 18. The high-pressure connection 76 is preferably connected to the pump housing 38 by a welding connection. However, screw connections with a securing means as the fixing method are not ruled out. Since, in most cases, the high-pressure connection 76 is fixed to the pump housing 38 perpendicularly to the movement axis 34, this also results in the valve bores 54 being arranged perpendicularly to the movement axis 34.

The first embodiment and the second embodiment of the valve arrangement 22 are each formed for different flow and pressure requirements of different systems. For example, a 6-cylinder engine without a so-called limp home requirement merely needs two single valves 48 in an outlet valve unit 24 and only one single valve 48 in a pressure-limiting valve unit 40. This is shown in the second embodiment in FIG. 5 and FIG. 6. In the case of a 3 cylinder engine with strict HP limp home requirements, on the other hand, only one single valve 48 is needed in the outlet valve unit 24, but a plurality of single valves 48 are needed in the pressure-limiting valve unit 40. This is shown in the first embodiment in FIG. 3 and FIG. 4.

In the high-pressure connection 76 or in the cartridge housing 72, the provided arrangement of the valve units 42, 44 is configured such that, depending on the application, the number of single valves 48 in the valve units 42, 44 can be varied. A modular attachment is thus possible, which can be tailored flexibly to customer-specific requests. To this end, although the space needed by the valve bores 54 for the single valves 48 is provided in the valve housing 46, these valve bores 54 are simply not realised if the maximum number of single valves 48 is not needed. Additional valve bores 54 can be added as required so that the desired additional single valve 48 may be installed.

The use of the valve arrangement 22 described above in a fuel injection system 10 in which the first valve unit 42 and the second valve unit 44 are formed as an outlet valve unit 24 and as a pressure-limiting valve unit 40 should only be regarded as an exemplary embodiment. Such a valve arrangement 22 can be used in all pumps with an integrated safety valve, for example in oil pumps.

1. A valve arrangement for a fuel injection system of an internal combustion engine, wherein:
the valve arrangement comprises a valve housing, a first valve unit having a first flow cross section, and a second valve unit having a second flow cross-section;
the first valve unit and the second valve unit are received in the valve housing and are connected antiparallel to one another;
the second valve unit comprises at least two mutually hydraulically separate, parallel-connected single valves which each have a respective single valve flow cross-section; and
the second flow cross-section of the second valve unit is formed by a sum of the single valve flow cross-sections of the single valves.

2. The valve arrangement according to claim 1, wherein the respective single valve flow cross-sections are different from one another, and/or respective opening pressures of the single valves are different from one another.

3. The valve arrangement according to claim 1, wherein the first valve unit comprises only one single valve, and/or the second valve unit comprises from three to five of the single valves.

4. The valve arrangement according to claim 1, wherein the single valves of the second valve unit and the first valve unit are arranged symmetrically around a valve housing longitudinal axis of the valve housing on a cross-sectional surface which is perpendicular to the valve housing longitudinal axis.

5. The valve arrangement according to claim 1, wherein the single valves of the second valve unit are arranged circularly symmetrically around the first valve unit on a cross-sectional surface which is perpendicular to a valve housing longitudinal axis of the valve housing.

6. The valve arrangement according to claim 1, wherein the valve housing has a respective associated valve bore for each one of the single valves, and wherein the valve bores are arranged parallel to one another, are mutually hydraulically separate from one another, and are configured as blind bores.

7. The valve arrangement according to claim 6, wherein the valve housing further has a valve bore for the first valve unit which includes convex outflow portions arranged radially with respect to a valve unit longitudinal axis of the first valve unit, and wherein the valve bores for the single valves of the second valve unit are respectively arranged between two of the convex outflow portions.

8. The valve arrangement according to claim 6, further comprising closing elements and/or valve springs, wherein the valve bores each respectively have a step that forms a valve seat for one of the closing elements or forms a supporting shoulder for one of the valve springs.

9. A fuel injection system for an internal combustion engine, comprising:
a high-pressure fuel pump having a pressure chamber and a pump piston arranged to be movable in the pressure chamber to pressurize a fuel during operation;
a high-pressure reservoir configured and arranged to store the fuel which is pressurized by the high-pressure fuel pump; and
a valve arrangement according to claim 1, which connects the pressure chamber of the high-pressure fuel pump to the high-pressure reservoir;
wherein the first valve unit serves as an outlet valve unit providing a barrier against a pressure force acting from the high-pressure reservoir and the second valve unit serves as a pressure-limiting valve unit providing a barrier against a pressure force acting from the pressure chamber, or the first valve unit serves as the pressure-limiting valve unit and the second valve unit serves as the outlet valve unit.

10. The fuel injection system according to claim 9, which further has a connecting bore between the pressure chamber and the high-pressure reservoir, in which connecting bore the valve arrangement is arranged,
wherein wall regions of the connecting bore form the valve housing, or the valve arrangement is formed in a cartridge housing which is pre-assembled outside the fuel injection system and is fixed in the connecting bore.
